(19) United States
(12) Patent Application Publication
(10) Pub. No.: US 2015/0042503 A1
(43) Pub. Date: Feb. 12, 2015

(54) METHOD OF TARGET DETECTION

(71) Applicant: THE UNIVERSITY OF MELBOURNE, Melbourne, Victoria (AU)

(72) Inventors: Mark Richard Morelande, Melbourne (AU); Li Mei, Melbourne (AU); Robin J. Evans, Melbourne (AU)

(21) Appl. No.: 14/382,305

(22) PCT Filed: Mar. 1, 2013
(86) PCT No.: PCT/AU2013/000191

§ 371 Date: Aug. 29, 2014

(30) Foreign Application Priority Data
Mar. 2, 2012 (AU) 2012900835

(51) Int. Cl. G01S 13/04; G01S 7/02

(52) U.S. Cl. CPC G01S 13/04; G01S 7/02
USPC 342/27

(57) ABSTRACT

A method of target detection comprising transmitting a continuous wave (CW) waveform and a random step frequency (RSF) waveform from which return signals are to be monitored in a detection period, processing return signals received in the detection period based on the transmitted CW waveform to obtain Doppler shift data indicative of Doppler frequency shifts corresponding to one or more targets, and processing the return signals of the detection period based on the transmitted RSF waveform and the obtained Doppler shift data to obtain range information corresponding to one or more targets.

### FIELD

The invention relates to a method and an apparatus for obtaining information about at least one target. In one embodiment, the invention finds application in the automotive industry, however other applications are contemplated.

### BACKGROUND

In recent years the use of small radar devices has become increasingly popular and widespread, especially in the automotive industry for advanced driving assistance system applications such as collision avoidance/mitigation, adaptive cruise control, and blind spot detection.

Due to the implementation technology of such radar devices, there are many challenges to be faced such as severe power and complexity constraints placed on their design. For example, in some applications it is necessary to identify multiple targets within a wide field of view in relatively short in short time periods with only limited processing power.

Accordingly, there is a need for new techniques for detecting information about targets.

### SUMMARY

In a first aspect of the invention, there is provided a method of target detection comprising:
transmitting a continuous wave (CW) waveform and a random step frequency (RSF) waveform from which return signals are to be monitored in a detection period;
processing return signals received in the detection period based on the transmitted CW waveform to obtain Doppler shift data indicative of Doppler frequency shifts corresponding to one or more targets; and
processing the return signals of the detection period based on the transmitted RSF waveform and the obtained Doppler shift data to obtain range information corresponding to one or more targets.

In an embodiment, the method comprises receiving the return signals at a plurality of antennae.

In an embodiment, the method comprises processing the return signals of the detection period based on the transmitted RSF waveform and the obtained Doppler shift data to obtain azimuth information.

In an embodiment, the method comprises applying amplitude scaling to the CW waveform and the RSF waveform such that the amplitudes of the waveforms decreases during a transmission period.

In an embodiment, the amplitude scaling is linear.

In an embodiment, the method comprises transmitting the CW and RSF waveforms using time division multiplexing.

In an embodiment, the method comprises transmitting the CW and RSF waveforms using frequency division multiplexing.

In an embodiment, the method comprises transmitting different CW waveforms in different detection periods.

In an embodiment, the method comprises processing the return signals to obtain Doppler shift data by:
(a) determining a Doppler frequency of most significance from the return signals of the CW waveform in a first iteration and determining a Doppler frequency of most significance from a residual signal in each subsequent iteration;
(b) determining whether the determined Doppler frequency satisfies a significance criteria;
(c) estimating any determined Doppler frequency that satisfies the significance criteria; and
(d) removing any estimated Doppler frequency of interest from the return signal to form a residual signal in a first iteration and removing any estimated Doppler frequency in each subsequent iteration to update the residual signal; and
(e) repeating steps (a) to (d) until a Doppler frequency fails to satisfy the significance criteria and thereafter using each estimated Doppler frequency as the Doppler shift data.

In an embodiment, the method comprises, for each estimated Doppler frequency in the Doppler shift data:
(a) determining for each estimated Doppler frequency in the Doppler shift data, whether there are one or a plurality of Doppler shifts in the return signal of the RSF waveform corresponding to respective ones of a plurality of targets;
(b) for each estimated Doppler frequency where there is only one Doppler shift, computing the range and Doppler;
(c) for each Doppler frequency where there are one or a plurality of Doppler shifts:
   (i) computing range and Doppler shift for the most significant Doppler shift in the return signals of the RSF waveform at the estimated Doppler frequency for the most significant Doppler shift of most significance from an RSF residual signal in each subsequent iteration;
   (ii) removing any estimated Doppler frequency of interest from the return signal of the RSF waveform to form an RSF residual signal in the first iteration and updating the RSF residual signal in any subsequent iteration; and
   (iii) repeating steps (i) and (ii) until range and

Doppler frequency have been obtained for each target.

In a second aspect of the invention, there is provided an apparatus for target detection comprising:
a signal generator arranged to generate a continuous wave (CW) waveform and a random step frequency (RSF) waveform from which return signals are to be monitored in a detection period;
a transmitter for transmitting the CW and RSF waveforms;

and
a signal processor arranged to:
   process return signals received in the detection period based on the transmitted CW waveform to obtain Doppler shift data indicative of Doppler frequency shifts corresponding to one or more targets; and
   process the return signals of the detection period based on the transmitted RSF waveform and the obtained Doppler shift data to obtain range information corresponding to one or more targets.

In a third aspect of the invention, there is provided a signal processor for an apparatus for target detection, the signal processor arranged to:
process return signals received in a detection period based on a transmitted continuous wave (CW) waveform to obtain Doppler shift data indicative of Doppler frequency shifts corresponding to one or more targets; and
process the return signals of the detection period based on a transmitted random step frequency (RSF) waveform and the obtained Doppler shift data to obtain range information corresponding to one or more targets.

In a fourth aspect of the invention, there is provided computer program code which when executed by one or more processors, implements a method of target detection comprising:
processing return signals received in a detection period based on a transmitted continuous wave (CW) waveform to obtain Doppler shift data indicative of Doppler frequency shifts corresponding to one or more targets; and
processing the return signals of the detection period based on a transmitted random step frequency (RSF) waveform and the obtained Doppler shift data to obtain range information corresponding to one or more targets.

In an embodiment, the computer program code comprises code which when executed causes at least one of the one or more processors to generate a continuous wave (CW) waveform and a random step frequency (RSF) waveform from which return signals are to be monitored in the detection period.

The invention also provides a computer readable medium, or a set of computer readable mediums, comprising the computer program code.

### BRIEF DESCRIPTION OF DRAWINGS

Embodiments of the invention will now be described by way of example with reference to the accompanying drawings in which:

FIG. 1 is a schematic block diagram of a target information acquisition system of an embodiment;

FIG. 2 is a schematic block diagram of the receiver processing of the target information acquisition system of FIG. 1 for multiple antennas;

FIG. 3 illustrates amplitude scaling of the transmitted signal;

FIG. 4 shows a simulation scenario employed in the example;

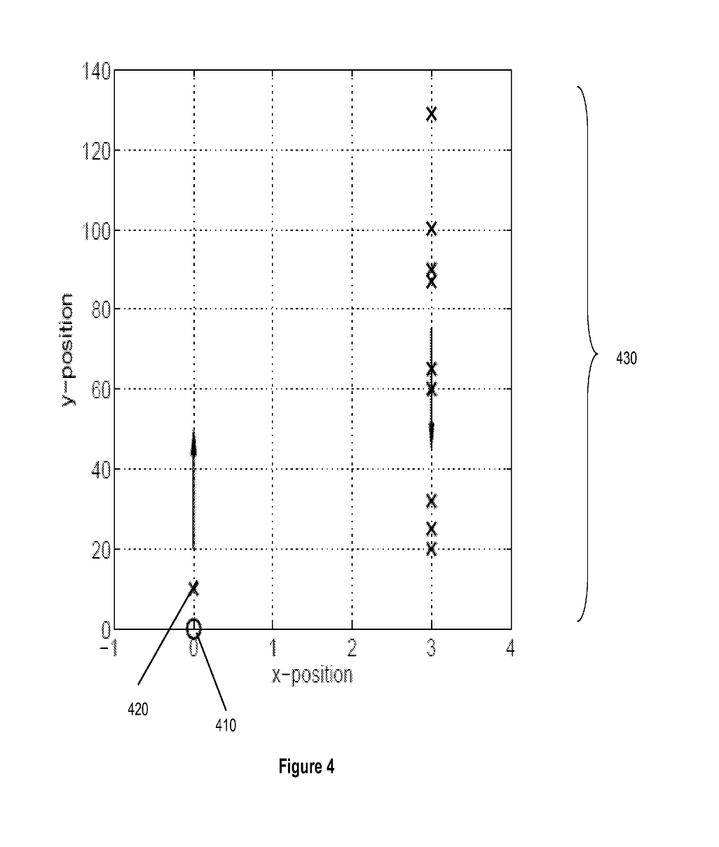

FIG. 5 is a schematic block diagram of receiver processing for a single antenna; and

FIG. 6 is a flow chart summarizing the method.

### DETAILED DESCRIPTION

The embodiments of the invention relate to obtaining information about one or more targets by transmitting a combination of a continuous wave (CW) waveform and a random step frequency (RSF) waveform, receiving return signals from one or more targets and processing the return signals to extract information about the target(s). Persons skilled in the art will appreciated that depending on the embodiment, the targets may be vehicles, bicycles, pedestrians etc.

In advantageous embodiments of the invention, the waveforms are designed to:
provide sufficient range, velocity, azimuth resolution and accuracy for the detection of multiple targets;
reduce computational complexity requirements; and
reduce interference effects.

In an advantageous embodiment, the system employs multiple antennas. In such an embodiment the system is able to extract information relating to the range, angle and azimuth of the targets. Such an embodiment is particularly suited to an automotive application where it is desirable to be able to obtain information about a plurality of different targets moving within the “scene” surrounding a vehicle.

In another embodiment, the system employs a single antenna, enabling a simpler RF architecture in a smaller package. While this provides no azimuth information, it finds application in embodiments where less information is required. For example, such a system could form part of a rear-facing warning system on a bicycle to warn the rider of approaching vehicles or other bicycles directly behind the rider's bicycle.

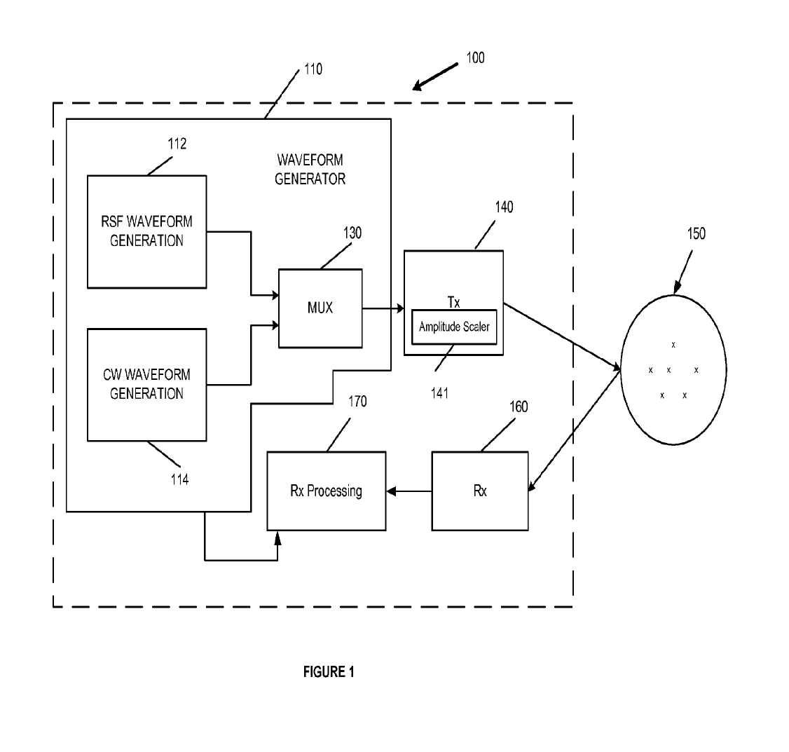

FIGS. 1 to 3 show an image acquisition system of a multiple antenna embodiment. FIG. 1 is a block diagram of the target information acquisition system 100. The system 100 has a digital waveform generator 110 which may be implemented, for example, by waveform software executed by a digital signal processor (DSP). The waveform generator 110 implements CW waveform generation 114 and RSF waveform generation 112. The RSF and CW waveforms are then multiplexed by multiplexer 130 to form a baseband waveform before being provided to the transmission section 140. Either time division or frequency division multiplexing may be employed. If time division multiplexing is employed, it is advantageous for the CW waveform to be transmitted before the RSF waveform in each detection period as Doppler information, extracted from the return CW signal is used information for processing of the RSF signal to significantly reduce the computational power required for range and azimuth determination of targets.

Persons skilled in the art will appreciate that in other embodiments the digital waveform generator may be implemented by a direct digital synthesizer (DDS). In such an embodiment, the waveform generator 110 employs digital flexible waveforms generation, for example, CW waveform generation, RSF waveform generation or a combination of CW waveform generation and RSF waveform generation in either the time or frequency domain. The RSF, CW or combined baseband waveforms are then up-converted to millimetre wave and then amplified by transmitter section 140 for transmission.

The transmitter 140 up converts the baseband waveform by mixing it with a carrier. Transmitter 140 also has a programmable gain amplifier 141 that implements amplitude scaling of the combined CW and RSF waveform to effectively increase dynamic range. That is, the amplitude scaling is such that during the sampling period signals from closer targets are scaled down so that they don't swamp return signals from more distant targets.

The transmitted signal impinges on one or more targets within scene 150 and the reflected return signals are collected by the antenna array of the receiver 160 simultaneously. The return signal is amplified by a low noise amplifier. The signal is then mixed with the carrier and further mixed with a signal related to the base band waveform by the receiver 160 before the signal is passed to the receiver processing section 170 to extract range, Doppler and azimuth information for the targets(s). In this respect, as indicated in FIG. 1, this extraction is performed based on the transmitted CW and RSF waveforms.

In this respect, it is assumed for the purposes of the present embodiment that the scene 150 contains q point targets with ranges r₁, . . . , r_{q}, radial velocities u₁, . . . , u_{q} and azimuths θ₁, . . . , θ_{q}. The aim of the system 100 is to determine the number of targets and estimate their ranges, radial velocities and azimuths. There are two return signals: one from the continuous-wave (CW) transmitted signal and one from the random stepped frequency (RSF) transmitted signal. The receiver 160 has an antenna array of m elements. In one example m=8.

Consider first the CW signal. The signal transmitted by transmitter 140 has the form

s₁(t)=A₁exp(jω₀t)

where ω₀ is the carrier frequency. The signal observed by the m-element receiver array is assumed to satisfy

$${y}_{1} ( t ) = {\sum }_{i = 1}^{q} {β}_{i} a ( {θ}_{i} ) {s}_{1} ( t - {τ}_{i} ) exp ( j {v}_{i} t ) + {w}_{1} ( t )$$

where τᵢ=2rᵢ/c, νᵢ=uᵢω₀/c, i=1, . . . , q and a(•)εC^{m} is the steering vector. The amplitude βᵢ of the ith target return depends on the target range. The steering vector includes the antenna response and azimuth-dependent time delays. The signal extractor 211 of the receiver processing module 170 has a CW waveform extraction module 211 that mixes the return signal with the carrier and samples with period T₁. The resulting sequence is,

$$\begin{matrix}{z}_{1} ( k {T}_{1} ) = {y}_{1} ( k {T}_{1} ) exp ( - j {ω}_{0} k {T}_{1} ) \\ = {\sum }_{i = 1}^{q} {β}_{i} a ( {θ}_{i} ) exp ( - j {ω}_{0} {τ}_{i} ) exp ( j {v}_{i} k {T}_{1} ) + {w}_{1} ( k {T}_{1} ) ,\end{matrix}$$

$$k = 1 , … , n .$$

The samples w₁(kT₁) are assumed to be independent zero-mean circular complex Gaussian random variables with unknown covariance matrix Q.

The RSF signal generated by the RSF waveform generation module 112 is composed of a sequence of short-interval tones, or chips. Let T₂ denote the chip interval and n the number of intervals. Then, the signal transmitted by transmitter 170 is, for tε((k−1)T₂,kT₂), k=1, . . . , n,

s₂(t)=A₂exp[jω₀t+pₖΔ(t−(k−1)T₂)]

where p₁, . . . , pₙ is a random permutation of the integers 1, . . . , n and Δ is the frequency spacing. The return signal at the receiver array is

$${y}_{2} ( t ) = {\sum }_{i = 1}^{q} {β}_{i} a ( {θ}_{i} ) {s}_{2} ( t - {τ}_{i} ) exp ( j {v}_{i} t ) + {w}_{2} ( t )$$

The signal extractor 210 has an RSF extraction module 212 for extracting the RSF return signals. Before sampling the return signal is mixed by the RSF extraction module with the carrier frequency ω₀ and, over the interval ((k−1)T₂, kT₂), with the frequency pₖΔ. After mixing and sampling at times kT₂, k=1, . . . , n, the RSF extraction module obtains

$$\begin{matrix}{z}_{2} ( k {T}_{2} ) = {y}_{2} ( k {T}_{2} ) exp [ - j ( {ω}_{0} t + {p}_{k} Δ ( t - ( k - 1 ) {T}_{2} ) ) ] \\ = exp ( - j {ω}_{0} {τ}_{i} ) {\sum }_{i = 1}^{q} {β}_{i} a ( {θ}_{i} ) exp ( - j {p}_{k} Δ {τ}_{i} ) exp ( j {v}_{i} k {T}_{2} ) + {w}_{2} ( k T )\end{matrix}$$

where w₂(kT) are assumed to be independent zero-mean circular complex Gaussian random variables with unknown covariance matrix Q.

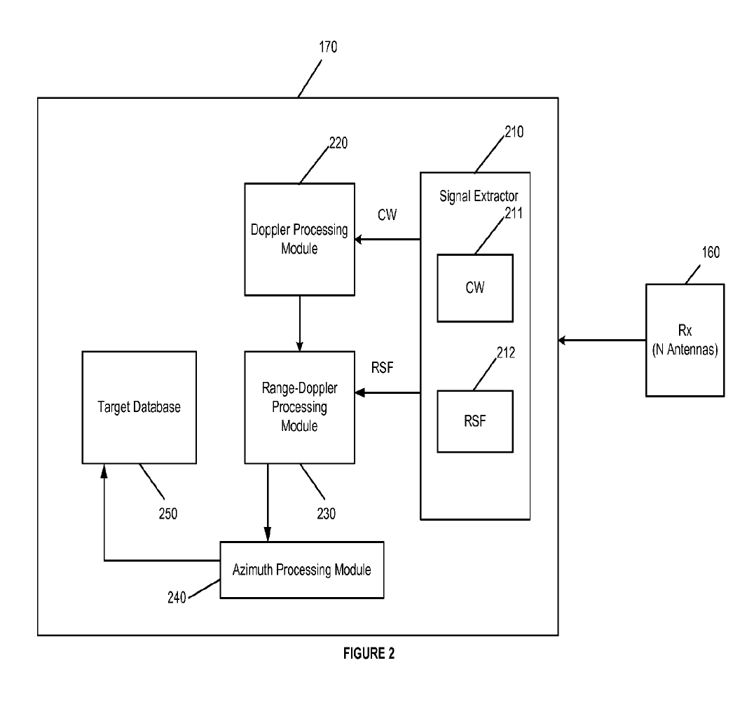

While FIG. 2 shows the signal extractor 210 as part of the Rx processing module 170 other architectures are possible. For example, the signal extractor 210 could be part of the receiver 160. In another embodiment, the receiver 160 mixes the return signal with the carrier before providing it to the Rx processing module for the signal extractor to perform signal extraction.

As shown in FIG. 2, once the CW and RSF waveform return signals are extracted by signal extractor 210, detection and estimation of the targets is done in three steps:
1. Detect Doppler frequencies of interest using the CW signal with Doppler processing module 220.
2. Detect and estimate targets in the range-Doppler plane using the RSF signal with range processing module 230.
3. Estimate target azimuths using the RSF signal with azimuth processing module 240.

### Doppler Frequency Detection

The measurement sequence z₁(T₁), . . . , z₁(nT₁) obtained by the receiver 160 can be used to estimate Doppler. At this point the system 100 does not need to accurately estimate the number of targets and their Dopplers. Rather, Doppler processing module 220 determines regions of high Doppler to reduce the complexity of the range-Doppler processing 230 using the RSF signal. In particular, the Doppler processing module 220 seeks the minimal set Vε{1, . . . , n} of bins such that

$$\{ {v}_{1} , … , {v}_{q} \} ⋐ {⋃}_{a ∈ V} {b}_{a}$$

where bₐ=[2π(a−½)/nT₁, 2π(a+½)/nT₁).

For the purposes of Doppler frequency detection the return signal is assumed to be

$${z}_{1} ( k {T}_{1} ) = {\sum }_{i = 1}^{q} {b}_{i} exp ( j {v}_{i} k {T}_{1} ) + {w}_{1} ( k {T}_{1} ) , \\ k = 1 , … , n \qquad ( 1 )$$

where bᵢεC^{m} is a vector of amplitudes. Note that the unstructured model of equation (1) replaces the steering vector a(θᵢ), which is completely determined by one parameter, with a vector bᵢ of arbitrary structure. The range-dependent phase is also not present in equation (1) as its range is not estimated. Detection of a single target is based on the statistic

max{I₁, . . . ,Iₙ} (2)

where, for k=1, . . . , n,

Iₖ=d(2πk/n)*\hat{R}⁻¹d(2πk/n)

with * the conjugate transpose and

$$d ( ω ) = 1 / n {\sum }_{t = 1}^{n} {z}_{1} ( t T ) exp ( - j ω t )$$

$$\hat{R} = 1 / n {\sum }_{t = 1}^{n} {z}_{1} ( t T ) {{z}_{1} ( t T )}^{*}$$

In order to simplify the null distribution of the test statistic, only the Fourier frequencies are used in (2). This can reduce the power of the detection procedure since Doppler frequencies may fall between the Fourier frequencies.

The statistic of equation (2) is used as part of a recursive procedure to determine the set V of significant Doppler frequencies. The Doppler processing module 220 computes the statistic (2) and tests its significance. If the test for significance is passed, then the component is estimated and the test is repeated with the residual obtained by removing the estimated component. Otherwise, if the test for significance fails, the procedure ends. This is shown in Algorithm 1. The threshold Γ_{m,n}(α) is chosen such that P(s>Γ_{m,n}(α))=α when q=0, i.e., no targets are present. Thus, Γ_{m,n}(α) controls the level of a single test of the significance of a periodogram peak. When no targets are present, the scaled periodogram ordinates 2nIₖ, k=1, . . . , n are asymptotically independent chi-squared random variables with 2m degrees of freedom. This property can be used to find the threshold Γ_{n,m}(α).

Algorithm 1: Detection of significant Doppler Frequencies

| 1 | set c = 1, V = Ø and εₖ = z₁(kT₁), k = 1, . . . , n |
|---|---|
| 2 | while c ≠ 0 do |
| 3 | compute |
| | $d ( 2 π k / n ) = 1 / n {\sum }_{t = 1}^{n} {ε}_{t} exp ( - j 2 π kt / n )$ |
| | $\hat{R} = 1 / n {\sum }_{t = 1}^{n} {ε}_{t} {ε}_{t}^{*}$ |
| 4 | compute the ordinates, for k = 1, . . . , n, |
| | Iₖ = d(2πk/n)* \hat{R}⁻¹ d(2πk/n) |
| 5 | compute the test statistic |
| | s = max {I₁, . . . , Iₙ} |
| 6 | if s > Γ_{m,n} (α) then |
| 7 | set V ← V ∪{k*} where k* = arg maxₖ Iₖ |
| 8 | compute the estimates |
| | $\hat{ν} = arg {max}_{ω} d ( ω ) \cdot {\hat{R}}^{- 1} d ( ω )$ |
| | \hat{b} = d(\hat{ν}) |
| 9 | remove the estimated component by |
| setting, for t = 1, . . . , n, | |
| | εₜ ← εₜ − \hat{b}exp(j\hat{ν}t) |
| 10 | else |
| 11 | set c ← 0 |
| 12 | end |
| 13 | end |

Once Doppler frequencies of interest have been identified from the CW signal, the RSF signal is used by range Doppler processing module 230 to estimate the ranges and precise Dopplers. Note that the number of bins identified by Algorithm 1 does not necessarily correspond to the number of targets present since there may be more than one target per Doppler bin. Thus, the RSF signal is also used to determine the number of targets present.

For the purposes of range-Doppler detection and estimation an unstructured version of the RSF signal model (6) is used by the range Doppler processing module 230:

$${z}_{2} ( k {T}_{2} ) = {\sum }_{i = 1}^{q} {b}_{i} exp ( - j {p}_{k} Δ {τ}_{i} ) exp ( j {v}_{i} k {T}_{2} ) + {w}_{2} ( k T )$$

In the embodiment, the quantity

J(ω,ψ)=f(ω,ψ)*\hat{R}⁻¹f(ψ,ψ)

is employed where

$$f ( ω , ψ ) = 1 / n {\sum }_{k = 1}^{n} {z}_{2} ( k {T}_{2} ) exp [ - j ( ω k {T}_{2} - ψ {p}_{k} Δ ) ]$$

$$\hat{R} = 1 / n {\sum }_{t = 1}^{n} {z}_{2} ( k {T}_{2} ) {{z}_{2} ( k {T}_{2} )}^{*}$$

For a single target, i.e., q=1, J (ω, ψ) will have a peak at (ω, ψ)=(ν₁, τ₁). Likewise, for q well-separated targets peaks will occur around (ω, ψ)=(νᵢ, τᵢ), i=1, . . . , q. However, targets which are not well-separated in the range-Doppler plane may not produce separate peaks. A recursive procedure similar to that of Algorithm 1 is used to allow detection of closely separated targets. This procedure is set out in Algorithm 2.

As before, the detection criterion is calculated at Fourier frequencies so that, when no targets are present, the periodogram ordinates are asymptotically independent chi-squared random variables. This simplifies setting of the threshold. In Algorithm 3, it is necessary to select a value for the number h of iterations. This can usually be quite small, for example three iterations.

### Algorithm 2: Range-Doppler Detection and Estimation Using the RSF Signal

| | |
|---|---|
| 1. | set c = 1, q = 0 and εₖ = z₂ (tT₂), t = 1, . . . , n |
| 2. | let r = \|V\| and V = {k₁, . . . , kᵣ} |
| 3. | while c ≠ 0 do |
| 4. | for u 1, . . . ,r, b = 1, . . . , n do |
| 5. | compute |
| | ${f}_{u , b} = 1 / n {\sum }_{t = 1}^{n} {ε}_{t} exp [ - j 2 π ( {k}_{u} t - {p}_{t} b ) / n ]$ |
| | $\hat{R} = 1 / n {\sum }_{t = 1}^{n} {ε}_{t} {ε}_{t}^{*}$ |
| | compute the ordinate |
| | J_{b+(u-1)n} = f_{u,b}^{*}\hat{R}⁻¹f_{u,b} |
| 6. | end |
| 7. | compute test statistic s = max {J₁, . . . , Jₙᵣ} |
| 8. | if s > Γ_{m,nr}(α) then |
| 9. | set q ← q + 1 |
| 10. | compute the estimate \hat{θ}_{q,0} = [\hat{b}'_{q,0}, \hat{ν}_{q,0}, \hat{τ}_{q,0}]′ as follows: |
| | $( {\hat{ν}}_{q , 0} , {\hat{τ}}_{q , 0} ) = arg {max}_{( ω , ψ )} J ( ω , ψ )$ |
| | \hat{b}_{q,0} = f(\hat{ν}_{q,0}, \hat{τ}_{q,0}) |
| 11. | given the initial estimate \hat{θ}₀ ← [\hat{θ}′, \hat{θ}′_{q,0}]′ use Algorithm 3 |
| | to refine the multiple target estimate |
| 12. | remove the estimated component by setting, for |
| | t = 1, . . . , n, |
| | ${ε}_{t} ← {z}_{2} ( tT ) - {\sum }_{i = 1}^{q} {\hat{b}}_{i} exp [ j ( {\hat{ν}}_{i} tT - {\hat{τ}}_{i} {p}_{t} Δ ) ]$ |
| 13. | else |
| 14. | set c ← 0 |
| 15 | end |
| 16 | end |

### Algorithm 3: Estimation of Multiple Dopplers and Ranges

| | |
|---|---|
| 1. | set \hat{θ} = \hat{θ}₀ |
| 2. | for l = 1, . . . , h do |
| 3. | for i = 1, . . . , q do |
| 4. | compute the residual, for t = 1, . . . , n, |
| | εₜ = z₂(tT) − Σ_{a≠i} \hat{b}ₐexp[j(\hat{ν}ₐtT₂ − \hat{τ}ₐpₜΔ)] |
| | estimate the parameters of the ith target as: |
| | $( {\hat{ν}}_{i} , {\hat{τ}}_{i} ) = arg {max}_{( ω , ψ )} J ( ω , ψ )$ |
| | \hat{b}ᵢ = f(νᵢ, τᵢ) |
| 5. | end |
| 6. | end |

The final step in the algorithm is for the azimuth processing module 240 to estimate the azimuths using the RSF signal. At this point it is assumed that the number of targets and their ranges and Dopplers are known. The procedure is shown in Algorithm 4.

### Algorithm 4: Estimation of the Azimuths

| 1. | for i = 1, . . . , q do |
|---|---|
| 2. | compute the residual, for t = 1, . . . , n, |
| ${ε}_{t} = {z}_{2} ( tT ) - {\sum }_{a \neq i}^{ } {\hat{b}}_{a} exp [ j ( {\hat{ν}}_{a} {tT}_{2} - {\hat{τ}}_{a} {p}_{t} Δ ) ]$ | |
| 3. | estimate the amplitude and azimuth of the ith |
| | target as: |
| | ${\hat{θ}}_{i} = arg {max}_{θ} \frac{{\vert {a ( θ )}^{*} {\hat{R}}^{- 1} {\hat{b}}_{i} \vert}^{2}}{{a ( θ )}^{*} {\hat{R}}^{- 1} a ( θ )}$ |
| | ${\hat{β}}_{i} = \frac{{\vert {a ( {\hat{θ}}_{i} )}^{*} {\tilde{R}}^{- 1} {\hat{b}}_{i} \vert}^{2}}{{a ( {\hat{θ}}_{i} )}^{*} {\tilde{R}}^{- 1} a ( {\hat{θ}}_{i} )}$ |
| | where |
| | \tilde{R} = \hat{R} − bᵢbᵢ^{*} |
| 4. | end |

Target information can be stored in target database 250 for access by one or more connected systems. For example to issue warnings or take actions based of the information for each target. Examples of connected systems include collision warning systems, automated braking systems, or automated cruise control systems.

The limited dynamic range of the receiver 170 poses potential problems when it is desired to detect targets at a variety of ranges. The transit power required to detect distant targets is so large that returns from nearby targets will saturate the receiver 170. The embodiment mitigates this problem by adopting amplitude scaling within transmitter 170 which attenuates the amplitude of returns from nearby targets compared to those from distant targets. This can be achieved at the transmitter 170 by a scaling function ξ(•) which is periodic with period equal to the sampling period and, over a given period. Satisfies dξ(t)/dt<0. To see this, consider a scaling function applied to the transmitted CW signal.

The return signal is

$${y}_{1} ( t ) = {\sum }_{i = 1}^{q} {β}_{i} ξ ( t - {τ}_{i} ) a ( {θ}_{i} ) {s}_{1} ( t - {τ}_{i} ) exp ( j {v}_{i} t ) + {w}_{1} ( t )$$

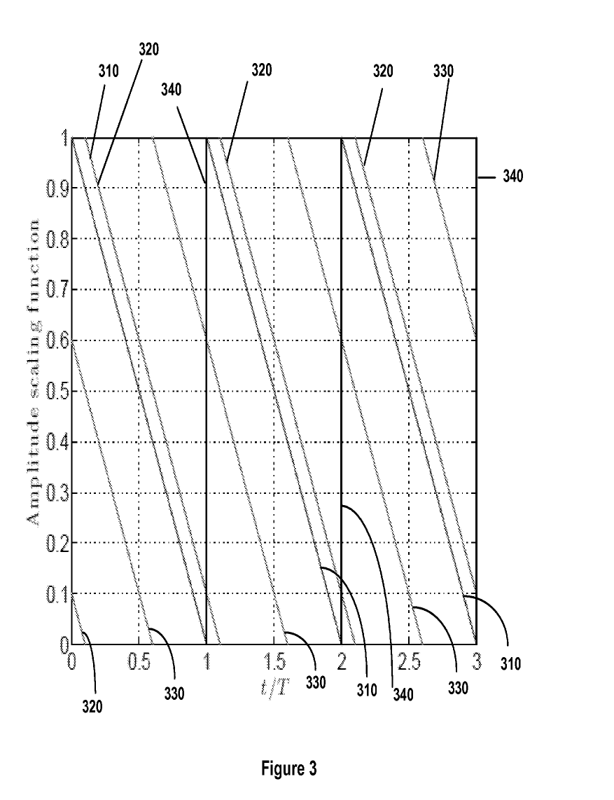

After mixing with the carrier and sampling with period T₁ we obtain

$${z}_{1} ( k {T}_{1} ) = {\sum }_{i = 1}^{q} {β}_{i} ξ ( {T}_{1} - {τ}_{i} ) a ( {θ}_{i} ) exp ( - j {ω}_{0} {τ}_{i} ) exp ( j {v}_{i} k {T}_{1} ) + {w}_{1} ( k {T}_{1} ) , \\ k = 1 , … , n .$$

where the embodiment employs the periodicity of ξ(•). As the delay τᵢ decreases, the value of ξ(T₁−τᵢ) decreases so that nearby targets will be attenuated compared to distant targets. This is illustrated in FIG. 3 for a scaling function which is a linear function of time. The reduction, at sampling instants, of the amplitude of targets nearby, i.e., those with a smaller delay, compared to distant targets is clearly evident. Amplitude scaling plotted against time for no delay, a delay of τ=T/10 320 and a delay of τ=3T/5 330. The vertical lines 340 indicate sampling instants. Persons skilled in the art will appreciate that other scaling functions can be used, for example, the signal can be scaled at a slower rate initially and more rapidly towards the end of the transmission period.

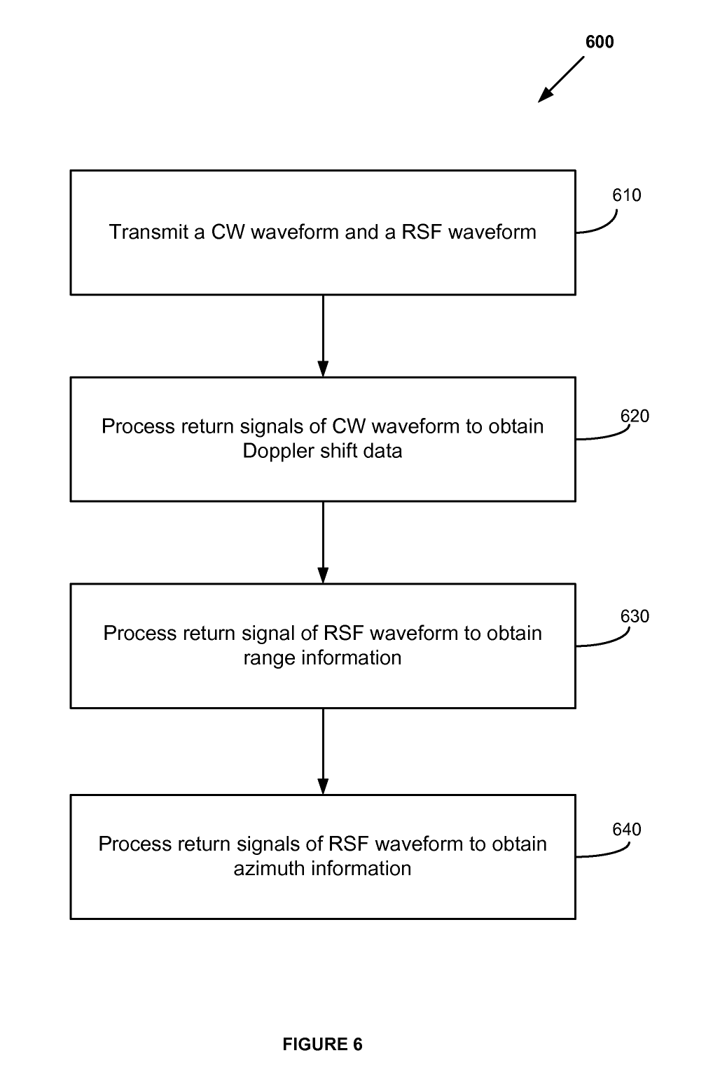

Accordingly, it will be appreciated that the method 600 can be summarized as shown in FIG. 6 as transmitting 610 a CW waveform and an RSF waveform, processing 620 return signals of the CW waveform to obtain Doppler shift data, processing 630 return signals of the RSF waveform to obtain range information, and, in some embodiments, processing 640 the RSF waveform to obtain azimuth information.

### Example

The simulation analysis adopts a scenario intended to mimic a real situation involving a car moving shown in FIG. 2. There is one car directly in front of the radar moving in the same direction and nine cars in the next lane moving towards the radar. The oncoming targets have almost equal speeds. The parameters for the CW signal are: ω₀=154π Grad/s, n=1000, A₁=5000 and T₁=2 ms. The parameters for the RSF signal are: ω₀=154π Grad/s, n=1000, Δ=π krad/s, A₂=5000 and T₂=2 ms. The receiver array has m=8 elements. The amplitude scaling function implemented by amplitude scaler 141 is set to ξ(t)=1−(t−kTᵢ)/Tᵢ for tε[kTᵢ, (k+1)Tᵢ), as shown in FIG. 3.

The additive noise covariance matrix is drawn from the Wishart distribution with 20 degrees of freedom and then scaled to be unit-determinant. With these parameters the return from the nearest target has a SNR of 7.4 dB while the return from the most distant target has a SNR of −14.3 dB. Algorithms 1 and 2 require selection of the level a of each significance test. In the example, both algorithms are used with α=10⁻³.

The performance of the algorithm was assessed by averaging over 1000 measurement realisations. For each measurement realisation, the estimates returned by the algorithm are assigned to the targets using an assignment algorithm. Estimates which are within a certain region of the parameter values of the target to which they are assigned are deemed to be true target detections, otherwise they are false detections. In the example, the number of true detections for each target as well as the accuracy of the parameters estimates, as measured by the RMS position error. The results are shown in Table 1. Also shown are the Cramer-Rao bounds for single target position estimation. The results show that the algorithm is capable of reliably and accurately locating a reasonably large number of targets. One feature to note in the results is that the detection results obtained for the −10.59 dB target are worse than those obtained for −10.92 and −11.95 dB targets. This is because the Doppler frequency of this target falls close to the midpoint between two Fourier frequencies.

TABLE 1
Simulation results for the scenario of FIG. 2.

| Target | SNR | Detection | RMS position | |
|---|---|---|---|---|
| number | (dB) | probability | error (cm) | CRB (cm) |
| 1 | 7.45 | 1.000 | 0.58 | 0.54 |
| 2 | 0.84 | 1.000 | 2.16 | 2.41 |
| 3 | −0.19 | 1.000 | 3.97 | 3.88 |
| 4 | −1.57 | 1.000 | 6.64 | 5.64 |
| 5 | −6.97 | 1.000 | 18.47 | 18.38 |
| 6 | −7.76 | 1.000 | 21.18 | 21.43 |
| 7 | −10.59 | 0.981 | 40.46 | 37.82 |
| 8 | −10.92 | 0.999 | 42.27 | 40.42 |
| 9 | −11.95 | 0.999 | 53.22 | 49.96 |
| 10 | −14.34 | 0.765 | 88.66 | 82.48 |

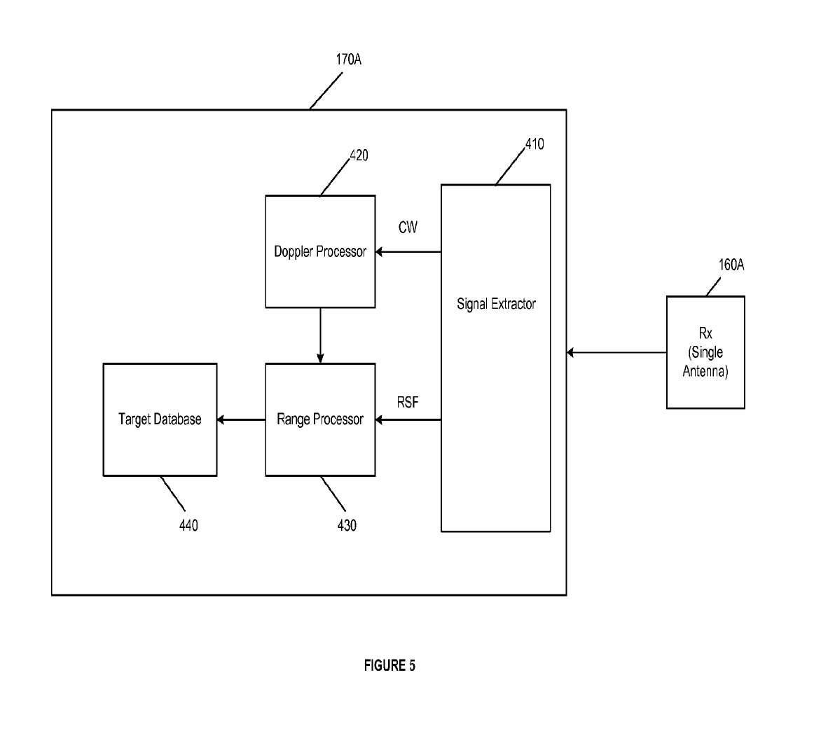

FIG. 5, illustrates an alternative embodiment where there is only a single antenna in the receiver 160B. The return signals are extracted by signal extractor 410 of Rx processing module 170B in a manner analogous that described above in relation to FIG. 2, however, as there is only a single antenna there is insufficient information to extract angle information. Accordingly, while Dopplers may be estimated by Doppler processor 420 using a similar recursive procedure to that described in relation to FIG. 2 above, only range information is extracted by Range processor 430 and stored in target database 440.

In the above description certain steps are described as being carried out by a processor, it will be appreciated that such steps will often require a number of sub-steps to be carried out for the steps to be implemented electronically, for example due to hardware or programming limitations.

The methods of the preferred embodiment will typically be provided in dedicated circuitry. However, the methods can also be provided by supplying as program code used to configure processing circuitry to carry out the method; that is a set of instructions implemented by one or more processors of an apparatus. Such program code may be supplied in a number of forms. For example, it could be supplied as a data signal written to an existing memory device associated with a processor or an existing memory such as an EPROM could be replaced with a new memory containing the program code. If the code is written to the memory, it can be supplied in accordance with known techniques such as on another tangible computer readable medium such as a disc, thumb drive, etc. or by download from a storage device on a remote computer. Further depending on the architecture, the program code may reside in a number of different locations. For example, in memories associated with separate processors that carry out specific aspects of the method. In such an example, the set of memories provide a set of computer readable mediums comprising the computer program code. The actual program code may take any suitable form and can readily be produced by a skilled programmer from the above description of the methods (including the described algorithms).

Herein the term “processor” is used to refer generically to any device that can generate and process digital signals. However, typical embodiments will use a digital signal processor optimised for the needs of digital signal processing.

It will be understood to persons skilled in the art of the invention that many modifications may be made without departing from the spirit and scope of the invention. It will also be apparent that certain features of embodiments of the invention can be employed to form further embodiments.

For example, while the above embodiments describe employing the same CW waveform in each detection period, it will be appreciated that the CW waveform could be frequency hopped between detection periods or less regularly. Frequency hopping the CW waveform advantageously reduces the potential for interference from other target information acquisition systems. Further, it will be appreciated that constraints may be placed on the degree of randomness of the RSF waveform, for example to avoid RSF tones being generated in the same frequency band as the CW waveform.

Similarly, in some embodiments, the receiver may have fewer receive chains than antenna elements. For example, instead of eight antenna elements and eight receive chains being used to obtain return signals simultaneously, four antenna elements (a first subset of antenna elements) may be connected using appropriate switching circuitry to four receive chains to obtain return signals in a first time period and a second four antenna elements (a second subset complementary to the first subset) may be connected to the four receive chains in a second time period. The data from the two periods can then be processed, in effect, as data from a single period in subsequent processing.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-24. (canceled)

25. A method of target detection comprising:
transmitting a continuous wave (CW) waveform and a random step frequency (RSF) waveform from which return signals are to be monitored in a detection period;
processing return signals received in the detection period based on the transmitted CW waveform to obtain Doppler shift data indicative of Doppler frequency shifts corresponding to one or more targets; and
processing the return signals of the detection period based on the transmitted RSF waveform and the obtained Doppler shift data to obtain range information corresponding to one or more targets.

26. A method as claimed in claim 25, comprising receiving the return signals at a plurality of antennae.

27. A method as claimed in claim 26, comprising processing the return signals of the detection period based on the transmitted RSF waveform and the obtained Doppler shift data to obtain azimuth information.

28. A method as claimed in claim 25, comprising applying amplitude scaling to the CW waveform and the RSF waveform such that the amplitudes of the waveforms decreases during a transmission period.

29. A method as claimed in claim 28, wherein the amplitude scaling is linear.

30. A method as claimed in claim 25, comprising transmitting the CW and RSF waveforms using time division multiplexing.

31. A method as claimed in claim 25, comprising transmitting the CW and RSF waveforms using frequency division multiplexing.

32. A method as claimed in claim 25, comprising transmitting different CW waveforms in different detection periods.

33. A method as claimed in claim 25, comprising processing the return signals to obtain Doppler shift data by:
(a) determining a Doppler frequency of most significance from the return signals of the CW waveform in a first iteration and determining a Doppler frequency of most significance from a residual signal in each subsequent iteration;
(b) determining whether the determined Doppler frequency satisfies a significance criteria;
(c) estimating any determined Doppler frequency that satisfies the significance criteria; and
(d) removing any estimated Doppler frequency from the return signal to form a residual signal in a first iteration and removing any estimated Doppler frequency in each subsequent iteration to update the residual signal; and
(e) repeating steps (a) to (d) until a Doppler frequency fails to satisfy the significance criteria and thereafter using each estimated Doppler frequency as the Doppler shift data.

34. A method as claimed in claim 25, comprising, for each estimated Doppler frequency in the Doppler shift data:
(a) determining for each estimated Doppler frequency in the Doppler shift data, whether there are one or a plurality of Doppler shifts in the return signal of the RSF waveform corresponding to respective ones of a plurality of targets;
(b) for each estimated Doppler frequency where there is only one Doppler shift, computing the range and Doppler;
(c) for each Doppler frequency where there are one or a plurality of Doppler shifts:
(i) computing range and Doppler shift for the most significant Doppler shift in the return signals of the RSF waveform at the estimated Doppler frequency for the most significant Doppler shift of most significance from an RSF residual signal in each subsequent iteration;
(ii) removing any estimated Doppler frequency of interest from the return signal of the RSF waveform to form an RSF residual signal in the first iteration and updating the RSF residual signal in any subsequent iteration; and
(iii) repeating steps (c)(i) and (c)(ii) until range and Doppler frequency have been obtained for each target.

35. An apparatus for target detection comprising:
a signal generator arranged to generate a continuous wave (CW) waveform and a random step frequency (RSF) waveform from which return signals are to be monitored in a detection period;
a transmitter for transmitting the CW and RSF waveforms;
a receiver for receiving return signals; and
a signal processor arranged to:
process return signals received in the detection period based on the transmitted CW waveform to obtain Doppler shift data indicative of Doppler frequency shifts corresponding to one or more targets; and
process the return signals of the detection period based on the transmitted RSF waveform and the obtained Doppler shift data to obtain range information corresponding to one or more targets.

36. An apparatus as claimed in claim 35, wherein the receiver comprises a plurality of antennae.

37. An apparatus as claimed in claim 36, wherein the signal processor is arranged to process the return signals of the detection period based on the transmitted RSF waveform and the obtained Doppler shift data to obtain azimuth information.

38. An apparatus as claimed in claim 35, comprising an amplitude scaler arranged to apply amplitude scaling to the CW waveform and the RSF waveform such that the amplitudes of the waveforms decreases during a transmission period.

39. An apparatus as claimed in claim 38, wherein the amplitude scaling is linear.

40. An apparatus as claimed in claim 35, wherein the transmitter transmits the CW and RSF waveforms using time division multiplexing.

41. An apparatus as claimed in claim 35, wherein the transmitter transmits the CW and RSF waveforms using frequency division multiplexing.

42. An apparatus as claimed in claim 35, wherein the transmitter transmits different CW waveforms in different detection periods.

43. An apparatus as claimed in claim 35, wherein the signal processor processes the return signals to obtain Doppler shift data by:
(a) determining a Doppler frequency of most significance from the return signals of the CW waveform in a first iteration and determining a Doppler frequency of most significance from a residual signal in each subsequent iteration;
(b) determining whether the determined Doppler frequency satisfies a significance criteria;
(c) estimating any determined Doppler frequency that satisfies the significance criteria; and
(d) removing any estimated Doppler frequency from the return signal to form a residual signal in a first iteration and removing any estimated Doppler frequency in each subsequent iteration to update the residual signal; and
(e) repeating steps (a) to (d) until a Doppler frequency fails to satisfy the significance criteria and thereafter using each estimated Doppler frequency as the Doppler shift data.

44. An apparatus as claimed in claim 43, wherein, for each estimated Doppler frequency in the Doppler shift data, the signal processor is arranged to:
(a) determine for each estimated Doppler frequency in the Doppler shift data, whether there are one or a plurality of Doppler shifts in the return signal of the RSF waveform corresponding to respective ones of a plurality of targets;
(b) for each estimated Doppler frequency where there is only one Doppler shift, compute the range and Doppler;
(c) for each Doppler frequency where there are one or a plurality of Doppler shifts:
(i) compute range and Doppler shift for the most significant Doppler shift in the return signals of the RSF waveform at the estimated Doppler frequency for the most significant Doppler shift of most significance from an RSF residual signal in each subsequent iteration;
(ii) remove any estimated Doppler frequency of interest from the return signal of the RSF waveform to form an RSF residual signal in the first iteration and updating the RSF residual signal in any subsequent iteration; and
(iii) repeat processes (c)(i) and (c)(ii) until range and Doppler frequency have been obtained for each target.
